(19) United States
(12) Patent Application Publication
(10) Pub. No.: US 2025/0330535 A1
(43) Pub. Date: Oct. 23, 2025

(54) AUDIO ENHANCING DEVICES AND MOBILE DEVICE CASES INCORPORATING THE SAME AND RELATED METHODS

(71) Applicant: Enhance It, Inc., Las Vegas, NV (US)

(72) Inventors: Darci Barlow, Alpine, UT (US); Hubert Barlow, Alpine, UT (US)

(21) Appl. No.: 18/849,249

(22) PCT Filed: Mar. 21, 2023
(86) PCT No.: PCT/US2023/064788

§ 371 Date: Sep. 20, 2024

Related U.S. Application Data
(60) Provisional application No. 63/321,772, filed on Mar. 21, 2022.

(51) Int. Cl. H04M 1/02

(52) U.S. Cl. CPC H04M 1/0203

(57) ABSTRACT

Disclosed are systems and methods for amplifying, enhancing, and improving the quality of sound from a mobile device. A sound enhancing mobile device case includes an encircling sidewall having an interior surface configured to retain a mobile device and an exterior surface, an opening in a portion of the interior surface, and a sound amplification element extending from the opening towards the exterior surface. The sound amplification element has a bottom surface disposed adjacent to the exterior surface of the encircling sidewall, a rear surface extending from the opening to the bottom surface, and opposing side surfaces extending along the rear surface from the opening to the bottom surface. A mobile device docking station can include the mobile device case and an electrical connection interface configured to mate with a mobile device for which the device case is configured.

### CROSS-REFERENCE TO RELATED APPLICATIONS

This application claims priority to, and the benefit of, U.S. Provisional Application Ser. No. 63/321,772, filed Mar. 21, 2022, and entitled “Sound Enhancing Electronic Device Case and Methods Related Thereto,” the entire contents of which are incorporated by reference herein in their entirety.

### BACKGROUND

In mobile devices, such as cellular phones and tablets, the audio speakers are often pointed away from the front of the device, where a user often faces. For example, speakers may be located on the bottom side of the cell phone and on the side of a tablet device. An ear piece speaker can also be located at the top of a cell phone or other handheld mobile device. When using the speakers on these devices, the sound (or sound pressure) exits the speaker and often travels away from the listener. This results in difficulty for the listener to hear the sound from the device due to the sound pressure moving away from the listener.

It is common for a listener to cup their hand under the speaker to attempt to increase or enhance the perceived sound volume and/or clarity from the device. Other listeners may place their device on a hard, reflective surface to improve sound volume and clarity of sound from the device. Some listeners may place their device in a cup holder or small drinking glass to increase sound volume and clarity. While these techniques improve sound and clarity from the device, the techniques are impractical in many circumstances and for long term use. For example, if a listener is listening to music while the listener cleans the house or does laundry, the listener's hands are preoccupied and unable to cup their hand under the speaker. Additionally, there may not exist a hard, reflective surface nearby.

### SUMMARY

Embodiments of the present disclosure include sound enhancing devices, sound enhancing mobile device cases, sound enhancing mobile device docking stations, and other devices and systems incorporating the same. Embodiments of the present disclosure further include methods of enhancing sound from a mobile device.

Some embodiments include a mobile device case having an encircling sidewall for retaining the mobile device. The sidewall has an interior surface configured to retain the mobile device and an exterior surface for gripping and/or protecting the mobile device from scuffs and other damage. Embodiment of the present disclosure include at least one opening in a portion of the interior surface. The opening can be or comprise a gap or void (in the interior surface and, optionally, in the body of the encircling sidewall. In some embodiments, opening 105 can be rounded, elliptical, rectangular, or any other suitable shape. Embodiment of the present disclosure further include a sound enhancing element extending from the opening towards the exterior surface (adjacent to the opening). The sound enhancing element includes a bottom surface disposed adjacent to the exterior surface of the encircling sidewall, a rear surface extending from the opening to the bottom surface, and opposing side surfaces extending along the rear surface from the opening to the bottom surface. Accordingly, the sound enhancing element can form a multi-sided (e.g., 4-sided) structure that at least partially bounds a sound enhancement chamber.

In some embodiments, the bottom surface can be (substantially) parallel to the opening (or the cross-section or diameter thereof).

In some embodiments, the rear surface of the sound enhancing element is sloped and/or curved between the opening and the bottom surface. For instance, all or a portion of the rear surface can extend from the opening to the bottom surface with a suitable radius of curvature and/or (diagonal) slope. In at least one alternative embodiment, all or a portion of the rear surface can be linear between the opening and the bottom surface and/or perpendicular to the opening and/or the bottom surface.

In some embodiments, one or both of the opposing sidewalls is sloped and/or curved. Illustratively, the opposing sidewalls can be co-linear, co-axial, or co-radial with the rear surface.

In some embodiments, the opening is separated from the bottom surface by at least 2 mm, at least 3 mm, at least 4 mm, or at least 5 mm. In some embodiments, the opening is separated from the bottom surface by less than 10 mm, less than 9 mm, less than 8 mm, or less than 7 mm. In some embodiments, the opening is separated from the bottom surface by 4-8 mm, 4.5-7.5 mm, or 5-7 mm.

In some embodiments, the opening and the sound enhancing element are disposed in a location of the sidewall corresponding to a position of a speaker on a mobile device for which the device case is configured.

In some embodiments, the device case further includes a second opening and a second sound enhancing element extending from the second opening towards the exterior surface (adjacent to the opening). The second opening can be disposed in a second portion of the interior surface. The second portion or second opening can be (immediately) adjacent to the first portion or first opening, as described above. In such embodiments, the intended mobile device for which the device case is configured can have dual lower speakers.

Alternatively, the second portion or second opening can be distal to the first portion or first opening. For example, the first portion and first opening can be disposed at the bottom of the device case and the second portion and second opening can be disposed at the top of the device case. In such embodiments, the intended mobile device for which the device case is configured can have one or more lower speakers and an upper speaker (or ear piece speaker).

Thus, in some embodiments, the opening and the sound enhancing element are disposed in a location of the sidewall corresponding to a position of a first speaker on a mobile device for which the device case is configured, and the second opening and the second sound enhancing element are disposed in a location of the sidewall corresponding to a position of a second speaker on a mobile device for which the device case is configured.

In some embodiments, the device case further includes a third opening and a third sound enhancing element extending from the third opening towards the exterior surface (adjacent to the opening). The third opening can be disposed in in a third portion of the interior surface. For instance, the third portion and/or third opening can be distal to the first portion and first opening, and the optional second portion and second opening. For example, the first portion and first opening, and the optional second portion and second opening, can be disposed at the bottom of the device case and the third portion and third opening can be disposed at the top of the device case. In such embodiments, the intended mobile device for which the device case is configured can have one or more lower speakers and an upper speaker (or ear piece speaker). Illustratively, the third opening and the third sound enhancing element are disposed on an upper portion of the encircling sidewall in a location of the sidewall corresponding to a position of a speaker on a mobile device for which the device case is configured.

In some embodiments, the device case is formed of thermoplastic. In some embodiments, the device case is 3D printed. In some embodiments, the device case is injection molded. In some embodiments, the device case is extrusion molded.

Some embodiments include a mobile device docking station. The docking station can include the sound enhancing mobile device case and an electrical connection interface configured to mate with a mobile device for which the device case is configured.

Some embodiments include a sound enhancing device. The device can have an upper surface, a lower surface, and a body extending between the upper surface and the lower surface. The device can also have an opening in a portion of the upper surface and a sound enhancing element extending through the body, from the opening towards the lower surface. The sound enhancing element can include a bottom surface disposed adjacent to the lower surface, a rear surface extending from the opening to the bottom surface, and opposing side surfaces extending along the rear surface from the opening to the bottom surface.

As described above (in connection with the sound enhancing mobile device case), the rear surface can be linear, sloped, or curved, and one or both of the opposing sidewalls is sloped or curved. Likewise, the opening can be separated from the bottom surface by: at least 2 mm, at least 3 mm, at least 4 mm, or at least 5 mm; less than 10 mm, less than 9 mm, less than 8 mm, or less than 7 mm; or 4-8 mm, 4.5-7.5 mm, or 5-7 mm.

Some embodiments include a mobile device docking station that includes the sound enhancing device and an electrical connection interface configured to mate with a mobile device for which the device case is configured.

Embodiments of the present disclosure also include methods of enhancing sound from a mobile device. The method generally includes inserting or otherwise attaching a mobile device to or into the disclosed sound enhancing mobile device case, sound enhancing device, or docking station, emitting sound or sound pressure from the mobile device through the opening in the sound enhancing mobile device case or sound enhancing device, and enhancing the sound emitted from the mobile device by means of the sound enhancing element.

An embodiment of the device includes a device case which resembles a typical device case (e.g., phone case, tablet case). Embodiments, however, additionally include scoop technology or curved openings corresponding to the location of the device speakers. The curved openings redirect the sound pressure towards the listener resulting in an enhance sound with improved clarity.

In another embodiment, the device includes a docking station which includes a holding device similar to a device case (e.g., phone case, tablet case) and a stand. In these embodiments, the holding device includes the scoop technology or curved openings corresponding to the location of the device speakers. The stand may allow the holding device to tilt or rotate and additionally may charge the device.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIGS. 1A-1F illustrate various views of a sound enhancing mobile device case in accordance with an embodiment of the present disclosure;

FIG. 2 illustrates a curved sound enhancing element of a sound enhancing mobile device case;

FIG. 3 illustrates a linear sound enhancing element of a sound enhancing mobile device case;

FIGS. 4A-4C illustrate a sound enhancing element of a sound enhancing mobile device case and having a first height and a first radius of curvature;

FIGS. 5A-5C illustrate a sound enhancing element of a sound enhancing mobile device case and having a second height and a second radius of curvature;

FIG. 6 illustrates a rear view of a sound enhancing mobile device case in accordance with an embodiment of the present disclosure;

FIG. 7 illustrates a step-out sound enhancing element of a sound enhancing mobile device case;

FIG. 8 illustrates a portion of a 3D printed sound enhancing mobile device case having dual sound enhancing elements;

FIG. 9 illustrates a portion of a 3D printed sound enhancing mobile device case having a single, large sound enhancing element;

FIG. 10 illustrates a portion of an injection molded sound enhancing mobile device case having dual sound enhancing elements;

FIGS. 11A-11H illustrate various views of a sound enhancing mobile device case in accordance with another embodiment of the present disclosure;

FIG. 12 illustrates 3D printed sound enhancing mobile device case having a lower sound enhancing element and an upper sound enhancing element;

FIGS. 13A-13C illustrate various views of a sound enhancing device in accordance with an embodiment of the present disclosure;

FIGS. 14A-14C illustrate various views of a sound enhancing device in accordance with another embodiment of the present disclosure;

FIGS. 15A-15C illustrate various views of a sound enhancing device in accordance with still another embodiment of the present disclosure;

FIGS. 16A-16C illustrate various views of a sound enhancing device in accordance with yet another embodiment of the present disclosure;

FIGS. 17A-17B illustrate various views of a 3D printed sound enhancing device having a curved rear surface and curved opposing sidewalls;

FIG. 18A illustrates a 3D printed sound enhancing device positioned to enhance the sound emitted from a lower main speaker of a mobile device;

FIG. 18B illustrates a 3D printed sound enhancing device positioned to enhance the sound emitted from an upper ear piece speaker of a mobile device;

FIG. 19A depicts baseline sound measurements of sound emitted from a mobile device speaker without a sound enhancing device;

FIG. 19B depicts sound measurements of sound emitted from a mobile device speaker having a sound enhancing device disposed against the main speaker thereof;

FIGS. 20-27 depict sound measurements of sound emitted from mobile devices with uniquely configured sound enhancing elements disposed against the speakers thereof;

FIG. 28 illustrates an example device case as a sleeve attachment;

FIG. 29 illustrates an example docking station; and

FIG. 30 illustrates an example docking station.

### DETAILED DESCRIPTION

Disclosed embodiments are directed towards scoop technology which is a curved opening in a device case or docking station which enhances (or amplifies) sound from device speakers. Some embodiments are particularly advantageous by redirecting sound from a device speakers towards a listener.

For example, device speakers are commonly found on the side of devices which means the sound pressure exiting the speakers moves away from the listener. Embodiments redirect the sound pressure towards the listener therefore improving sound volume and clarity. Embodiments provide a hands free solution where the listener may position their device in a way that is most convenient for them. Compared to common amplification or sound enhancement techniques, such as putting the device on a hard surface, cupping a hand over the speaker, using a cupholder, or placing the device in a glass, which frequently require the device to be in an awkward position or unusable by the listener.

An embodiment of the device includes a device case which resembles a typical device case (e.g., phone case, tablet case). Embodiments, however, additionally include scoop technology or curved openings corresponding to the location of the device speakers. The curved openings redirect the sound pressure towards the listener resulting in an enhanced (or amplified) sound with improved clarity.

In another embodiment, the device includes a docking station which includes a holding device similar to a device case (e.g., phone case, tablet case) and a stand. In these embodiments, the holding device includes the scoop technology or curved openings corresponding to the location of the device speakers. The stand may allow the holding device to tilt or rotate and additionally may charge the device.

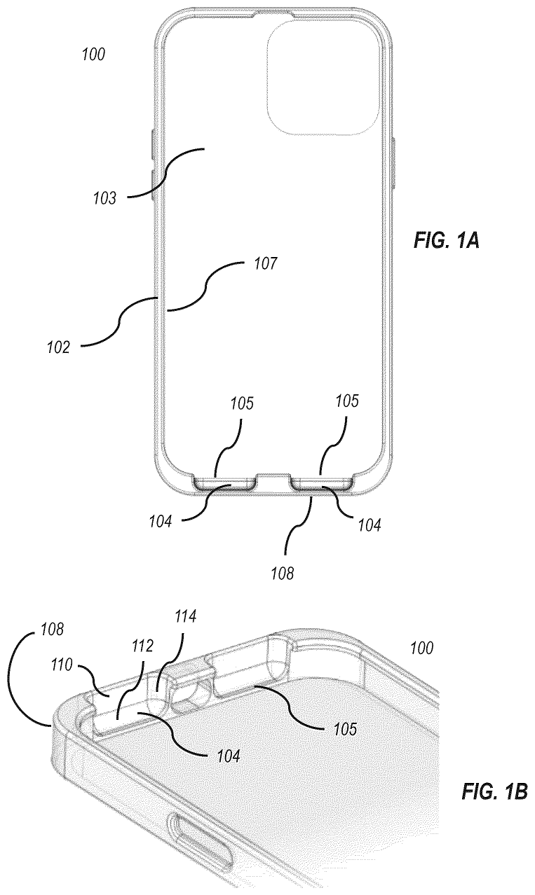

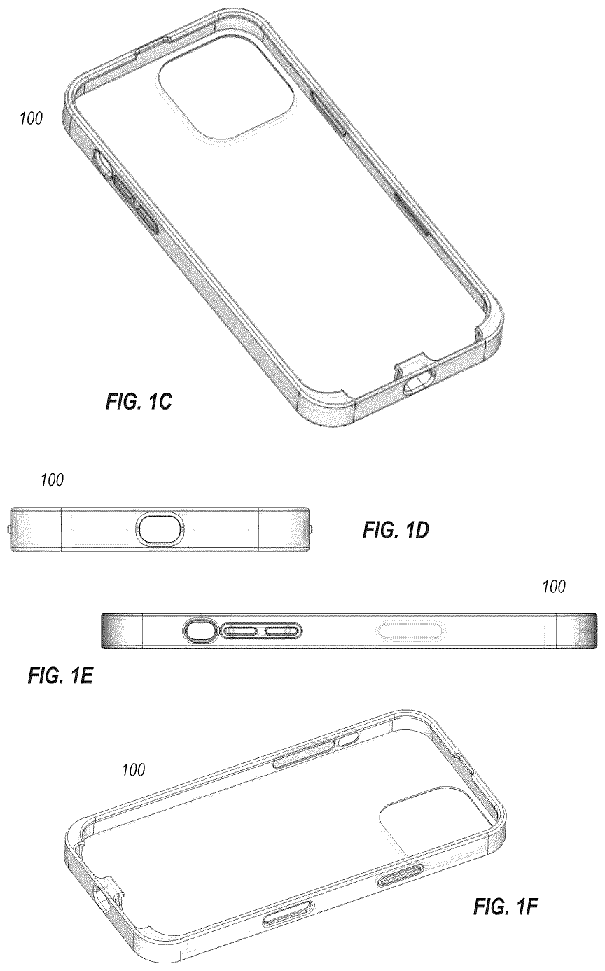

Turning now to the Figures, FIG. 1A-1F illustrate an example of a device case 100. As shown in FIG. 1A-1F, the device case 100 includes an encircling sidewall 102. Illustratively, device case 100 also includes a back portion 103 connected to encircling sidewall 102. While encircling sidewall 102 is illustrated as a completely encircling sidewall, in some embodiments, encircling sidewall 102 may only be partially encircling. For instance, portions of encircling sidewall 102 may have ornamental or functional gaps, holes, or other missing material. In some embodiments, back portion 103 can form or function as part of encircling sidewall 102, or may compensate for gaps, holes, or other missing material thereof.

It will also be appreciated that device case 100 may only cover a portion of the device. For example, the device case may be a sleeve that only covers the bottom side of the device and a portion of two sides of the device. In the sleeve embodiments, the device case 100 may or may not have a back portion 103.

In embodiments, the device case 100 may be formed of plastic, such as thermoplastic polyurethane (TPU). In other embodiments, the device cased 100 may be formed of metal, fabric, a mixture of plastics, or other appropriate materials. In some embodiments, the device case 100 may be created using 3D printing techniques. In other embodiments, the device case 100 may be created using standard manufacturing techniques.

FIGS. 1A-1F further depict two (or dual) openings 105 in the interior (or inner) surface 107 of sidewall 102; specifically, the lower portion of sidewall 102. Also depicted are two (or dual) sound enhancing elements 104, each extending from a respective opening 105 towards an exterior surface 108 of sidewall 102. FIG. 1B further illustrates a bottom surface 110 of sound enhancing element 104 disposed adjacent to exterior surface 108 of encircling sidewall 102. FIG. 1B further illustrates a rear surface 112 extending from opening 105 to bottom surface 110. FIG. 1B further illustrates opposing side surfaces 114 extending along rear surface 112 from opening 105 to the bottom surface 110. As depicted in FIG. 1B, opposing side surfaces 114 and rear surface 112 are curved.

It will be appreciated that alternative embodiments may have only one opening 104 and only one sound enhancing element 104. It will also be appreciated that alternative embodiments may have more than two openings 104 and more than two sound enhancing elements 104. For example, typical smart phones include one or more speakers on the bottom of the device and one or more ear piece speakers on the top of the device. Accordingly, any suitable number of opening(s) 104 can be included in order to enhance sound emitted from any number of speakers of a mobile device. In other embodiments, opening(s) 104 may be located in other locations of the device case 100 (e.g., multiple sides of the device case 100, on the back portion 103 of the device case 100, on the top side of the device case 100). In some embodiments, opening 105 can be rounded, elliptical, rectangular, or any other suitable shape. Openings 105 can have a cross-section, diameter, or other measurement suitable to accommodate a speaker of a mobile device for which the case is configured. For example, opening 105 can be at least 2 mm, 3 mm, 4 mm, or 5 mm long. In some embodiments, opening 105 can be less than about 15 mm, 14 mm, 13 mm, 12 mm, 11 mm, 10 mm 9 mm, 8 mm, 7 mm, 6 mm, 5 mm, or 4 mm long. In some embodiments, opening 105 can be about 2-12 mm, 2-11 mm, 2-10 mm, 2-9 mm, 2-8 mm, 2-7 mm, 2-6 mm, 2-5 mm, 2-4 mm, 2-3 mm, 3-12 mm, 3-11 mm, 3-10 mm, 3-9 mm, 3-8 mm, 3-7 mm, 3-6 mm, 3-5 mm, 3-4 mm, 4-12 mm, 4-11 mm, 4-10 mm, 4-9 mm, 4-8 mm, 4-7 mm, 4-6 mm, 4-5 mm, 5-12 mm, 5-11 mm, 5-10 mm, 5-9 mm, 5-8 mm, 5-7 mm, 5-6 mm, 6-12 mm, 6-11 mm, 6-10 mm, 6-9 mm, 6-8 mm, 6-7 mm, 7-12 mm, 7-11 mm, 7-10 mm, 7-9 mm, 7-8 mm, 8-12 mm, 8-11 mm, 8-10 mm, or 8-9 mm long. In other embodiments, opening 105 can be longer or shorter than the speaker length (or width).

Those skilled in the art will also appreciate that mobile device cases include holes, opening, gaps, etc., as known in the art, for providing access to mobile device features such as a charging port, volume button(s), menu or function button(s), camera(s), memory card slots, SIM card slots, and so forth. In at least one embodiment, device case 100 can further include a cutout portion corresponding to a location of a cellular receiver of a mobile device (e.g., a phone, a tablet) and/or a cutout portion corresponding to a wi-fi receiver of a mobile device. Traditional device cases cover the receiver which has negative impacts on reliability and accessibility of cellular networks. Embodiments allow for devices in the device case 100 to access cellular networks more easily.

FIGS. 1C-1F depict additional views of case 100.

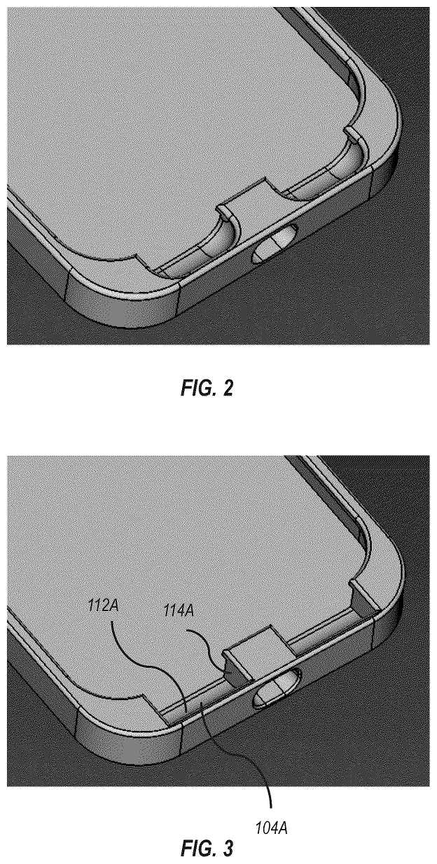

FIG. 2 illustrates a portion of a device case having dual curved sound enhancing elements. FIG. 3 illustrates a portion of a device case having dual linear sound enhancing elements. In particular, rear surface 112A and bottom surface 114A of having dual linear sound enhancing element 104A are linear, rather than curved.

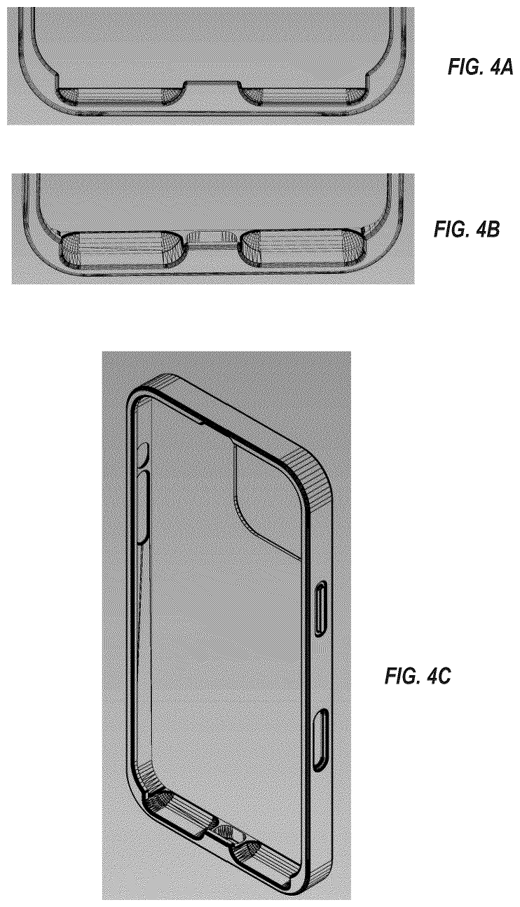

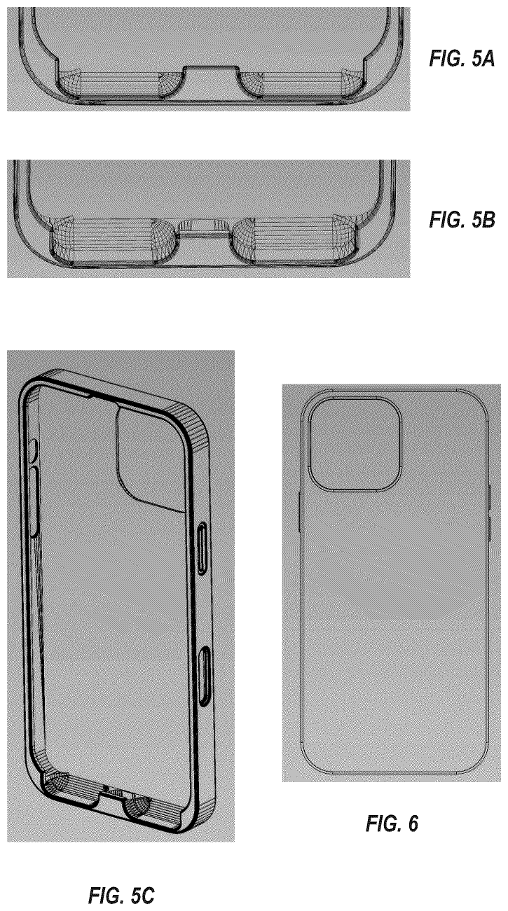

FIGS. 4A-4C illustrate a sound enhancing element of a sound enhancing mobile device case and having a first height and a first radius of curvature. Illustratively, the first height and first radius of curvature can constitute a low-profile sound enhancing element. FIGS. 5A-5C illustrate a sound enhancing element of a sound enhancing mobile device case and having a second height and a second radius of curvature. Illustratively, the second height and second radius of curvature can constitute a high-profile sound enhancing element.

Suitable heights and radii of curvature for sound enhancing elements according to embodiments of the present disclosure can vary. For example, in some embodiments, opening 105 can be separated from bottom surface 110 by at least 2 mm, 3 mm, 4 mm, or 5 mm. In some embodiments, opening 105 can be separated from bottom surface 110 by less than about 15 mm, 14 mm, 13 mm, 12 mm, 11 mm, 10 mm 9 mm, 8 mm, 7 mm, 6 mm, 5 mm, or 4 mm. In some embodiments, opening 105 can be separated from bottom surface 110 by about 2-12 mm, 2-11 mm, 2-10 mm, 2-9 mm, 2-8 mm, 2-7 mm, 2-6 mm, 2-5 mm, 2-4 mm, 2-3 mm, 3-12 mm, 3-11 mm, 3-10 mm, 3-9 mm, 3-8 mm, 3-7 mm, 3-6 mm, 3-5 mm, 3-4 mm, 4-12 mm, 4-11 mm, 4-10 mm, 4-9 mm, 4-8 mm, 4-7 mm, 4-6 mm, 4-5 mm, 5-12 mm, 5-11 mm, 5-10 mm, 5-9 mm, 5-8 mm, 5-7 mm, 5-6 mm, 6-12 mm, 6-11 mm, 6-10 mm, 6-9 mm, 6-8 mm, 6-7 mm, 7-12 mm, 7-11 mm, 7-10 mm, 7-9 mm, 7-8 mm, 8-12 mm, 8-11 mm, 8-10 mm, or 8-9 mm.

In some embodiments, the radius of curvature of rear surface 112 can be between about 5 mm and about 30 mm. Those skilled in the art will appreciate that a suitable radius of curvature can be determined based on the separation distance between opening 105 and bottom surface 110.

In some embodiments, sound enhancing elements (or rear surface and/or opposing side surfaces thereof) can have a round, curved, or scoop shape while in other embodiments sound enhancing elements (or rear surface and/or opposing side surfaces thereof) can have a linear shape. The linear shape of sound enhancing elements (or rear surface and/or opposing side surfaces thereof) can be sloped (diagonal) relative to the plane of the opening, bottom surface, and/or outer surface of the encircling sidewall.

FIG. 6 illustrates a rear view of a sound enhancing mobile device case in accordance with an embodiment of the present disclosure;

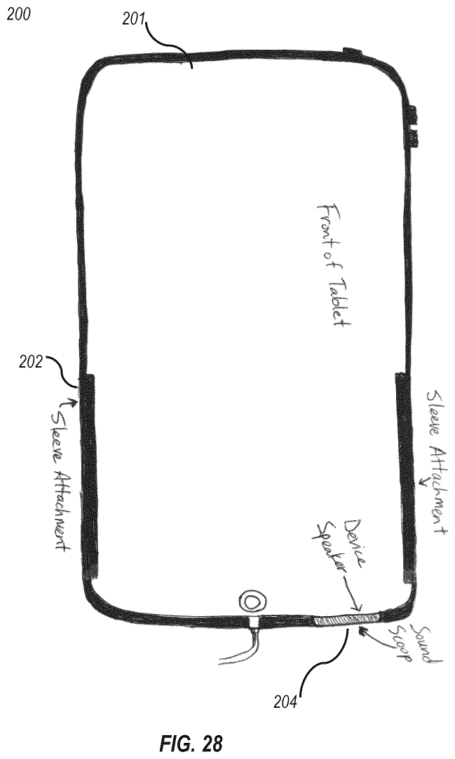

Referring now to FIG. 28, FIG. 28 illustrates an example device case 200 with a device 201 (e.g., a tablet, as shown in FIG. 28) with incorporated scoop technology as a curved opening 204. In this example embodiment, the device case 200 is a sleeve with only three sides 202. The device case 200 slides onto the device 201 and partially covers two of the three sides 202 and fully covers one of the three sides 202 located between the other two sides 202. FIG. 28 shows an example embodiment with only one curved opening 204 which is located in a corresponding position of the speakers on the device 201.

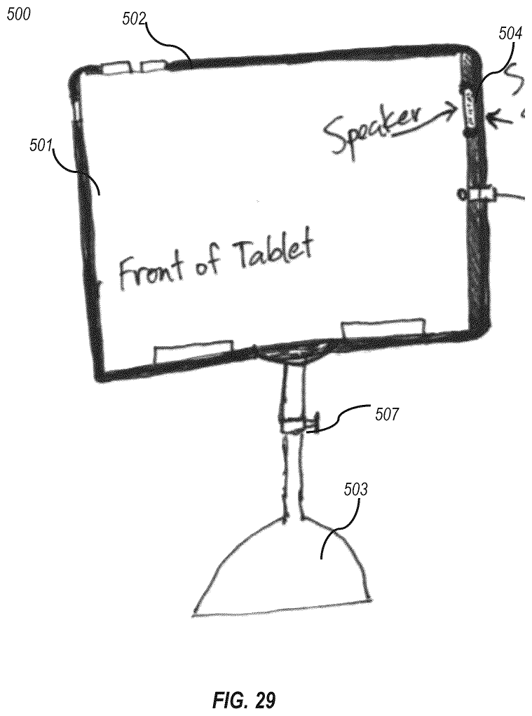

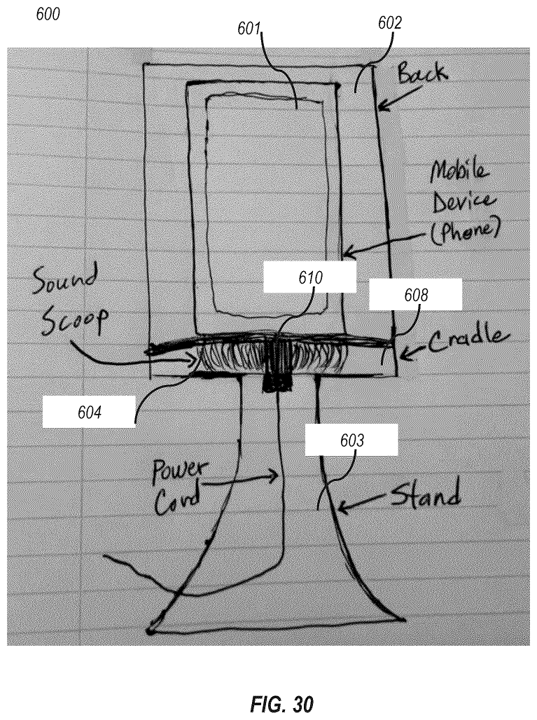

Turning now to FIGS. 29 and 30 which illustrate example docking stations 500 and 600, respectively. FIG. 29 illustrates a docking station 500 which includes a holding device 502 which is configured to hold a device 501 and further includes a stand 503. The holding device 502 includes scoop technology incorporated into a curved opening 504.

The docking station 500 may be formed of a plastic, or combination of plastics, metal, wood, leather, or fabric. In one embodiment, the docking station 500 is formed of thermoplastic polyurethane (TPU). In some embodiments, the holding device 502 is formed of a different material than the stand 503. For example, the holding device 502 may be formed of TPU while the stand 503 is formed of a metal.

In some embodiments, the stand 503 may be configured to rotate or tilt the holding device 502. For example, the stand 503 may allow the holding device 502 to be in a horizontal or vertical position or tilt forward or back. The stand 503 may have a locking mechanism 507, which locks the position of the holding device 502. In some embodiments, the locking mechanism 507 may be a friction fit piece, a spinning locking mechanism, a bendable material, or other appropriate means to hold the holding device 502 in a set position.

Similarly to FIGS. 1 through 4, the holding device 502 may include one or more curved openings 504 located at various positions. In some embodiments, the curved openings 504 correspond to locations of the speakers found on the device 501. In some embodiments, the device may be a phone, tablet, or other device which may include multiple speakers and multiple corresponding curved openings 504. In some embodiments, the curved openings 504 may be placed in common locations for device speakers, however, the curved openings 504 may not correspond to every speaker in a device 501.

Turning now to FIG. 30, FIG. 30 illustrates another example of a docking station 600. In this example embodiment, the docking station 600 includes a holding device 602 and a stand 603. The holding device 602 is configured to hold a device 601 such as a tablet or mobile device, as shown in FIG. 30. The docking station 600 additionally includes a cradle 608 which may include the scoop technology as a curved opening 604 and optionally a charging port 610. The charging port 610 may optionally run through the stand 603. In some embodiments, the charging port 610 automatically charges the device 601 when the device 601 is placed in the holding device 602. In other embodiments, the user may have to plug the device 601 into the charging port 610.

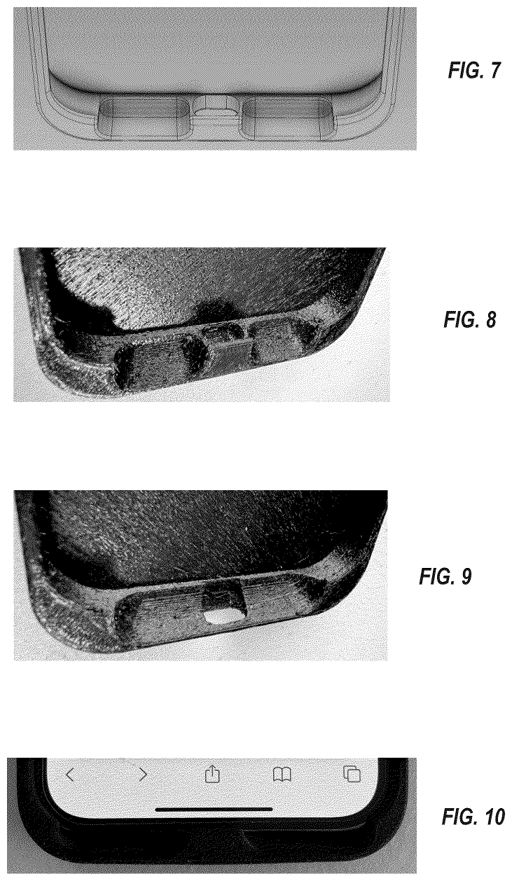

As shown in FIG. 30, some embodiments may include a large curved opening 604 which is similar in length to a side of the holding device 602. In some embodiments, the holding device 602 may include multiple large curved openings 604 on multiple sides of the holding device 602. In yet other embodiments, the curved opening 604 may correspond to a location of a speaker of the device 601 similarly to FIGS. 1A-12.

### Experimental Results

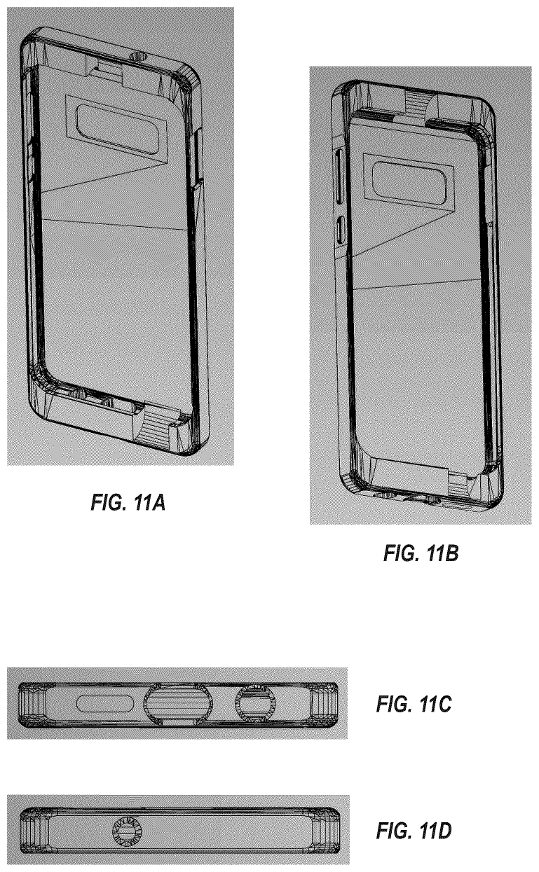

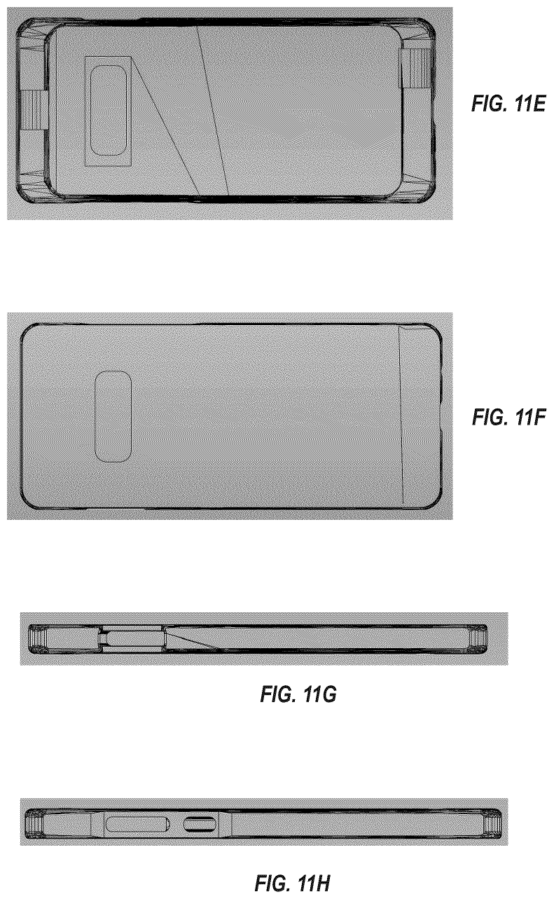

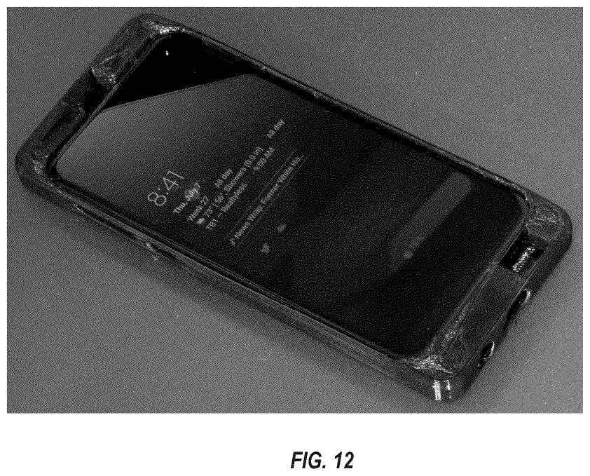

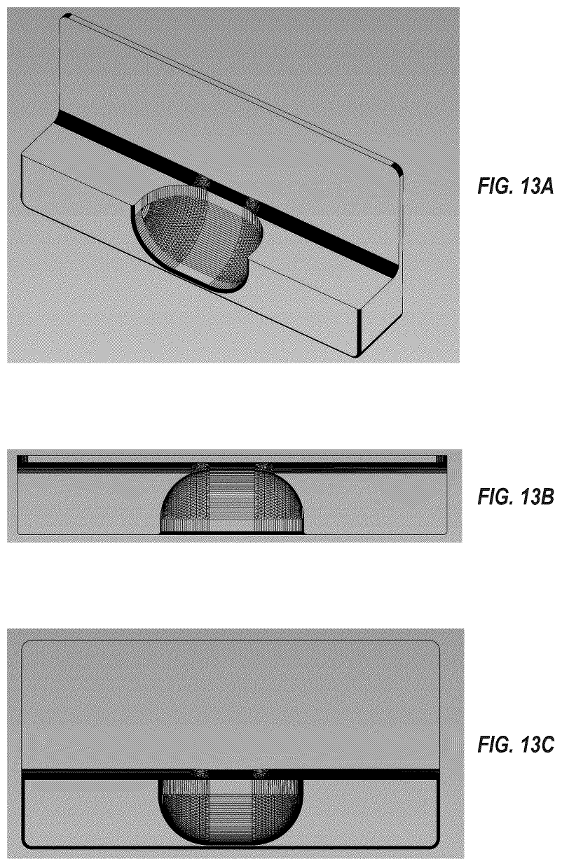

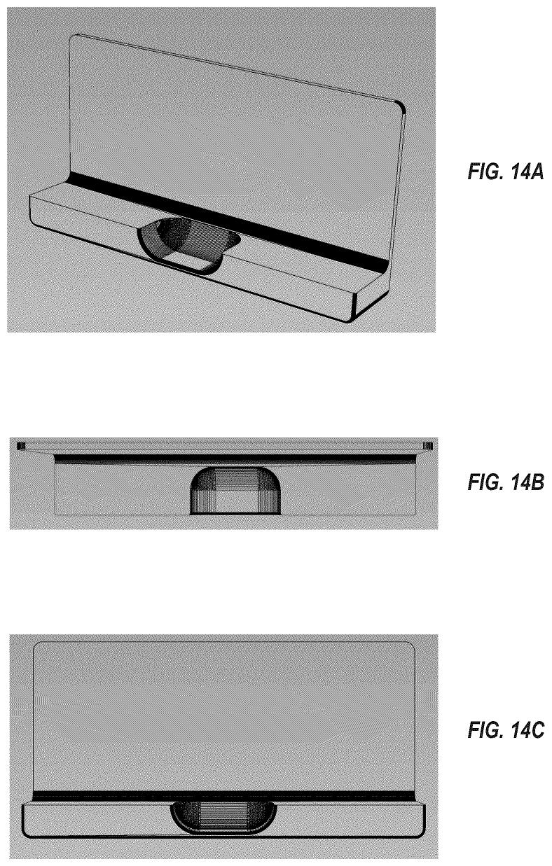

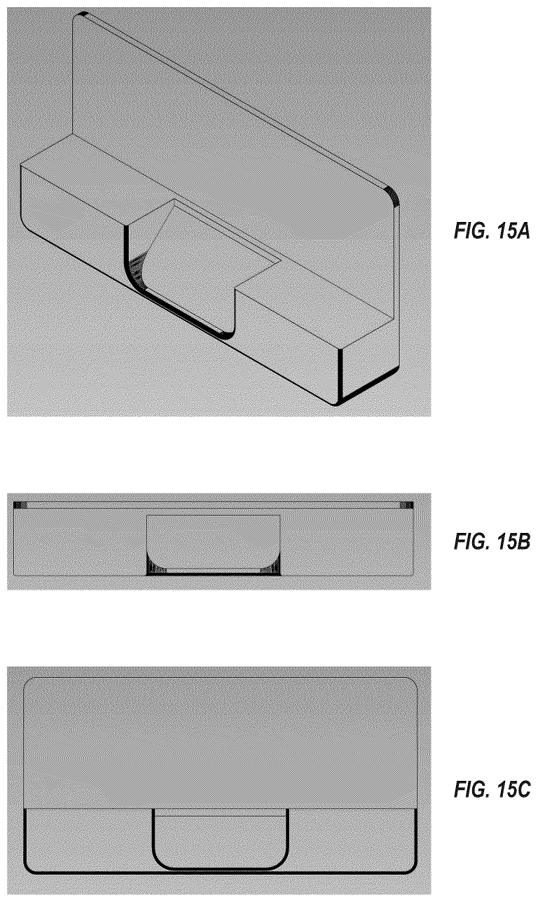

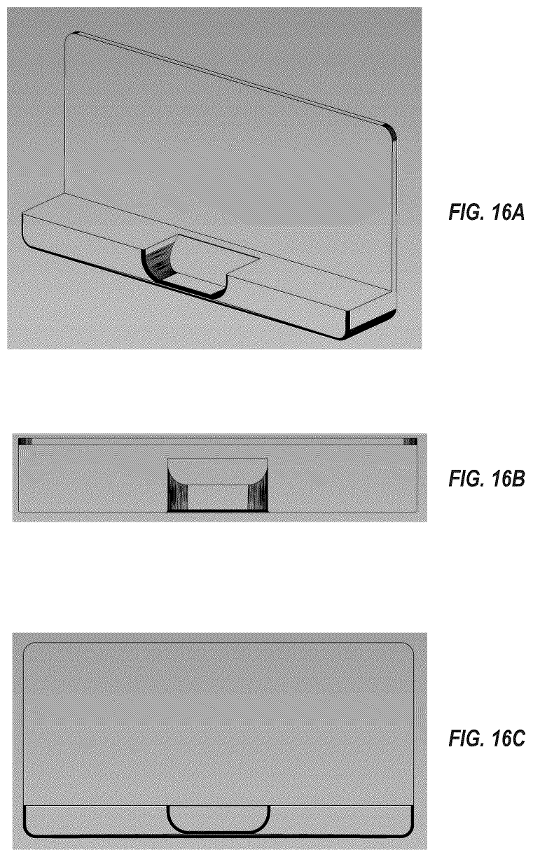

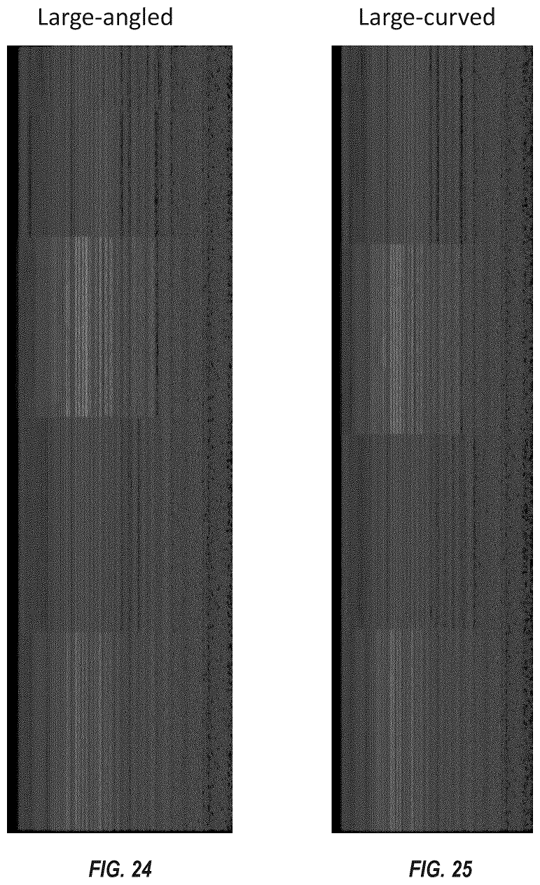

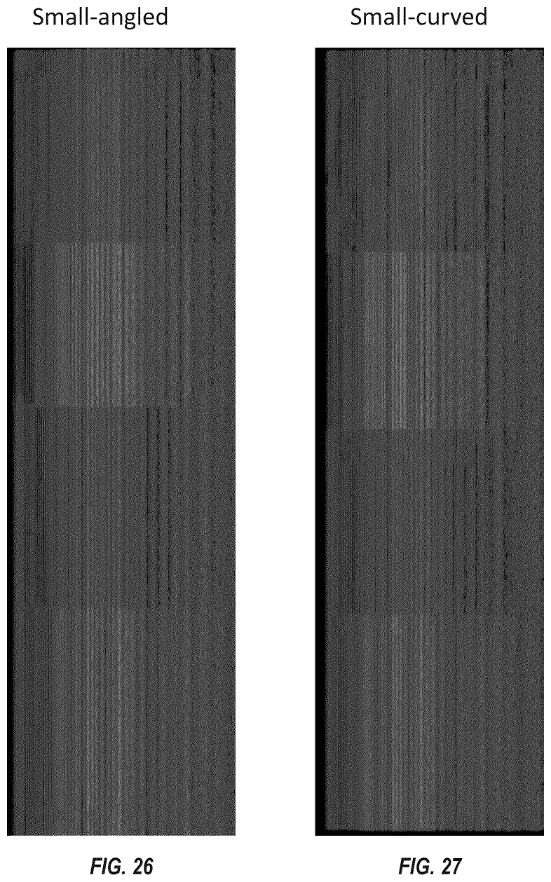

FIGS. 24-27 depict audio measurements corresponding to experimental tests presented in Table 1, below, performed using the device and system illustrates in the Figures (see, for example, FIGS. 11A-11H and 12, in view of FIGS. 13A-16C.

TABLE 1

| | | | | | | |
|---|---|---|---|---|---|---|
| | Main | | | Both | | |
| Part | Speaker | Baseline | Increase | Speakers | Baseline | Increase |

Recorded from an SM7B at 12″ from Samsung S10e generating white noise.
Readings measured in db over −14 db LUFS. Larger numbers indicate larger volume.

| | | | | | | |
|---|---|---|---|---|---|---|
| Small Angled | 4.3 | 1.1 | 3.2 | 6.2 | 1.3 | 4.9 |
| Small Curved | 4.6 | 0.9 | 3.7 | 6.4 | 1.1 | 5.3 |
| Large Angled | 4.6 | 0.8 | 3.8 | 6.5 | 0.9 | 5.6 |
| Large Curved | 4.9 | 0.7 | 4.2 | 6.7 | 1 | 5.7 |

Recorded from an SM7B at 12″ from Samsung S10e playing a podcast.
Readings measured in db over −14 db LUFS. Larger numbers indicate larger volume.

| | | | | | | |
|---|---|---|---|---|---|---|
| Small Angled | −3.4 | −5.9 | 2.5 | −2.2 | −5.7 | 3.5 |
| Small Curved | −2.9 | −5 | 2.1 | −1.7 | −5.8 | 4.1 |
| Large Angled | −2.8 | −6.1 | 3.3 | −0.8 | −5.6 | 4.8 |
| Large Curved | −2.7 | −6.3 | 3.6 | 0 | −5.7 | 5.7 |

Initially, tests were performed on a Samsung S10 mobile phone and conducted at varying levels of loudness employing white and pink noise, at varying distances from the mobile device. In speaker mode, the S10 uses both the top and bottom speaker simultaneously. Tests were conducted with a single sound enhancing element at only the bottom speaker, as well as dual sound enhancing elements (at both speakers). Employing the sound enhancing element at the speaker at the top of the phone added an additional −1.5 db of amplification or audio enhancement.

Further experiments were performed to determine the sound quality with different scoop (rear surface) shapes. Each experiment used a Samsung s10 device in different cases (having different sound enhancing elements). The results for each experiment were measured in db relative to −14 LUFS. For the first experiment, one case, the scoop walls had flat side walls and in another case, the scoop walls had curved side walls. Each wall had a length of 8 mm. A delta value was calculated which compared the difference between the measured sound for each test. The results are shown in Table 2 below.

TABLE 2

| | Test 1 | Test 2 | Test 3 | Test 4 | Test 5 |
|---|---|---|---|---|---|
| Flat Side | 0.8 | 0.8 | 3 | 3.1 | 5.9 |
| Walls | | | | | |
| Curved | 1 | 1.3 | 3.1 | 3.2 | 6.3 |
| Side Walls | | | | | |
| Delta | 0.2 | 0.5 | 0.1 | 0.1 | 0.4 |

The results from this experiment show that the scoop with curved side walls, or three curved walls, performs better than the scoop with flat side walls, or only one curved wall.

Additional experiments compared flat side walls, round side walls, a round scoop, and an elliptical scoop. The flat side walls and the round side walls had a length of 8 mm. The round scoop and the elliptical scoop had a scoop size of 6.5 mm. The second experiment tested both white noise and pink noise. The second experiment used a tripod mic and a microfiber surface. A delta value was calculated which compared the difference between the measured sound for each test. The results from the second experiment are shown in Table 3 below.

TABLE 3

| | | With Scoop | Without Scoop | Delta |
|---|---|---|---|---|
| White | Flat Side Walls | −1.2 | −7.5 | 6.3 |
| Noise | Round Side Walls | −1.5 | −7.7 | 6.2 |
| | Round Scoop | −1.5 | −7.8 | 6.3 |
| | Elliptical Scoop | −2.3 | −8.1 | 5.8 |
| Pink | Flat Side Walls | −6.7 | −11.9 | 5.2 |
| Noise | Round Side Walls | −6.7 | −11.9 | 5.2 |
| | Round Scoop | −6.7 | −11.9 | 5.2 |
| | Elliptical Scoop | −7.1 | −11.9 | 4.8 |

The results from the second experiment shown in table two show an improvement in sound in every case where the scoop is present compared to a device with no scoop. This indicates that the scoop technology enhances or amplifies sound. Next, the results show that a round scoop enhances or amplifies sound better than an elliptical scoop.

The third experiment tested the scoop size. Cases were created with a 8.0 mm, 6.5 mm, and 5.0 mm scoop. Each case was tested with both white noise and pink noise. The third experiment used a tripod mic and a microfiber surface. A delta value was calculated which compared the difference between the measured sound for each test. The results from the third experiment are shown in Table 4 below.

TABLE 4

| | Scoop Size | With | Without | |
|---|---|---|---|---|
| | (mm) | Scoop | Scoop | Delta |
| White | 8.0 | −0.8 | −7.2 | 6.4 |
| Noise | 6.5 | −1.2 | −7.4 | 6.2 |
| | 5.0 | −1.4 | −7.5 | 6.1 |
| Pink | 8.0 | −3.4 | −8.4 | 5.0 |
| Noise | 6.5 | −3.6 | −8.4 | 5.0 |
| | 5.0 | −3.8 | −8.4 | 5.0 |

The results of experiment three shown in Table 4 show only a slight difference between the 8.0 mm, 6.5 mm, and 5.0 mm scoop size. This indicates a reduction in scoop size will have minimal, or even a null, change in sound. Therefore, a smaller scoop size can be produced in some embodiments.

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

The term audio or sound “enhancing” is used herein to denote the focusing, clarifying, amplifying, or otherwise improving of sound, sound pressure, or sound quality emitted from a mobile device, and may be used interchangeably with focusing, clarifying, amplifying, or improving, unless context clearly dictates otherwise.

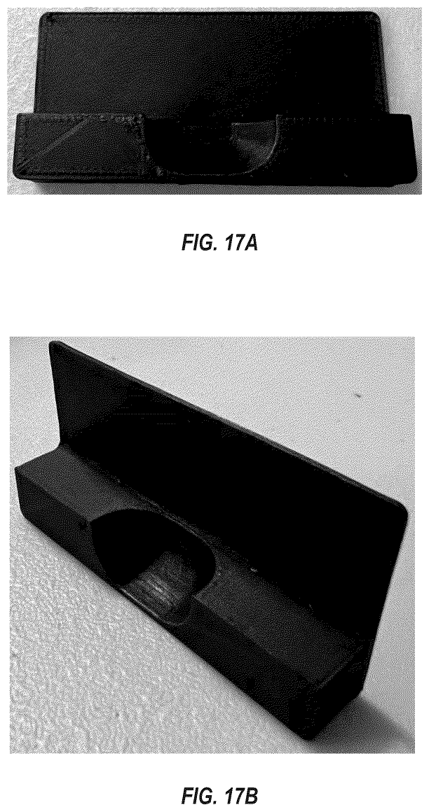

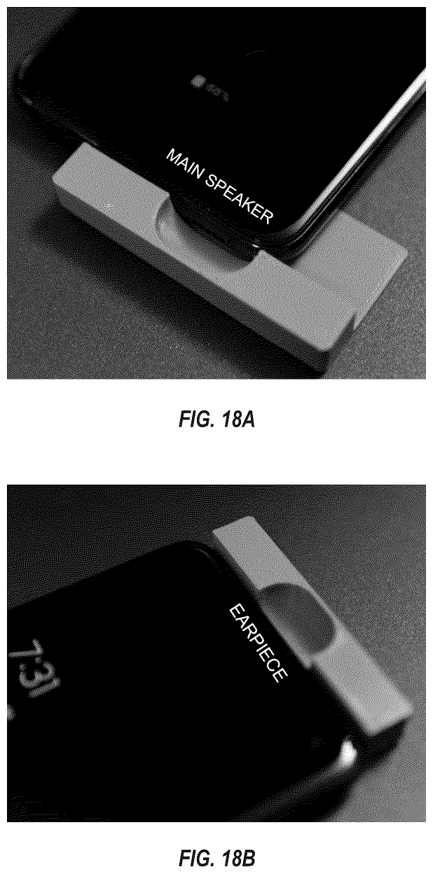

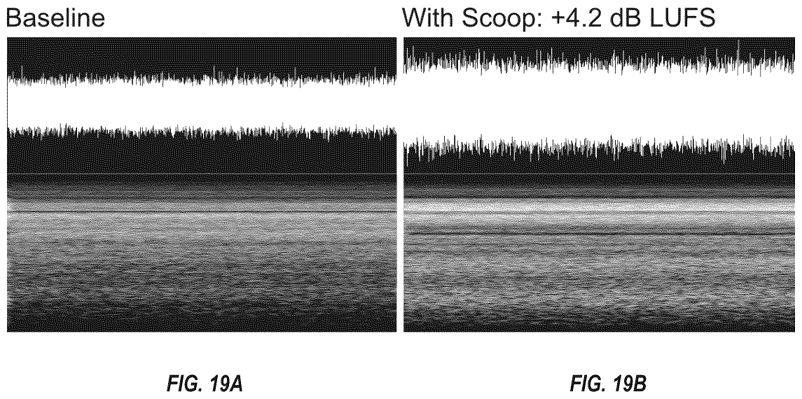

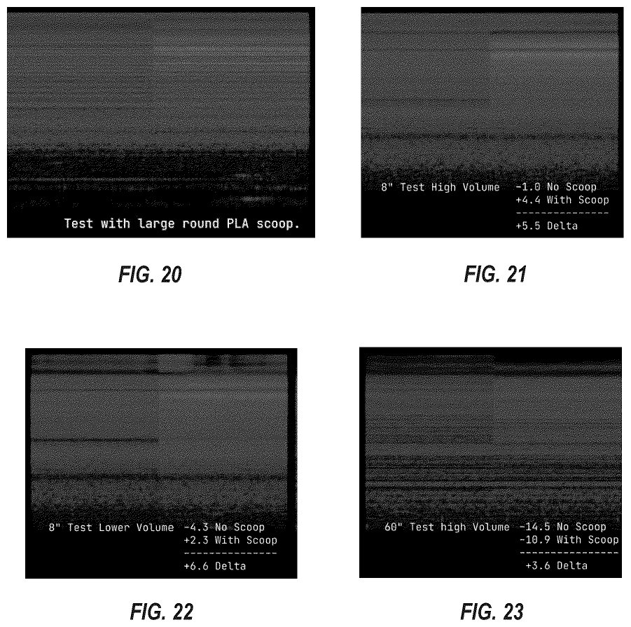

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. For example, the multiple curved openings shown in FIGS. 1A-10 may be incorporated into the sleeve device case shown in FIG. 28. Additionally, the sleeve device case shown in FIG. 28 may be incorporated into the other figures. The holding device shown in the docking station of FIGS. 29 and 30 may include any of the device cases shown in FIGS. 1A-12 or any of the devices shown in FIGS. 13A-18B. Thus, disclosure of certain features relative to a specific embodiment of the present disclosure should not be construed as limiting application or inclusion of said features to the specific embodiment. Rather, it will be appreciated that other embodiments can also include such features.

1. A mobile device case, comprising:
an encircling sidewall having:
an interior surface configured to retain a mobile device; and
an exterior surface;
an opening in a portion of the interior surface; and
a sound enhancing element extending from the opening towards the exterior surface, the sound enhancing element comprising:
a bottom surface disposed adjacent to the exterior surface of the encircling sidewall;
a rear surface extending from the opening to the bottom surface; and
opposing side surfaces extending along the rear surface from the opening to the bottom surface.

2. The mobile device case of claim 1, wherein the rear surface is sloped or curved.

3. The mobile device case of claim 2, wherein one or both of the opposing side surfaces is sloped or curved.

4. The mobile device case of claim 1, wherein the opening is separated from the bottom surface by:
at least 2 mm, at least 3 mm, at least 4 mm, or at least 5 mm;
less than 10 mm, less than 9 mm, less than 8 mm, or less than 7 mm; or
4-8 mm, 4.5-7.5 mm, or 5-7 mm.

5. The device case of claim 1, wherein the opening and the sound enhancing element are disposed in a location of the encircling sidewall corresponding to a position of a speaker on a mobile device for which the device case is configured.

6. The device case of claim 1 further comprising:
a second opening in a second portion of the interior surface; and
a second sound enhancing element extending from the second opening towards the exterior surface, the second sound enhancing element comprising:
a bottom surface disposed adjacent to the exterior surface of the encircling sidewall;
a rear surface extending from the opening to the bottom surface; and
opposing side surfaces extending along the rear surface from the opening to the bottom surface.

7. The device case of claim 6, wherein the second opening is disposed adjacent to the opening on a lower portion of the encircling sidewall.

8. The device case of claim 7, wherein:
the opening and the sound enhancing element are disposed in a location of the encircling sidewall corresponding to a position of a first speaker on a mobile device for which the device case is configured; and
the second opening and the second sound enhancing element are disposed in a location of the encircling sidewall corresponding to a position of a second speaker on a mobile device for which the device case is configured.

9. The device case of claim 5 further comprising:
a third opening in a third portion of the interior surface; and
a third sound enhancing element extending from the third opening towards the exterior surface, the third sound enhancing element comprising:
a bottom surface disposed adjacent to the exterior surface of the encircling sidewall;
a rear surface extending from the opening to the bottom surface; and
opposing side surfaces extending along the rear surface from the opening to the bottom surface.

10. The device case of claim 9, wherein the third opening and the third sound enhancing element are disposed on an upper portion of the encircling sidewall and in a location of the encircling sidewall corresponding to a position of a speaker on a mobile device for which the device case is configured.

11. The device case of claim 1, wherein the case is formed of thermoplastic.

12. A mobile device docking station, comprising the mobile device case of claim 1 and an electrical connection interface configured to mate with a mobile device for which the device case is configured.

13. A sound enhancing device, comprising:
an upper surface, a lower surface, and a body extending between the upper surface and the lower surface;
an opening in a portion of the upper surface; and
a sound enhancing element extending through the body, from the opening towards the lower surface, the sound enhancing element comprising:
a bottom surface disposed adjacent to the lower surface;
a rear surface extending from the opening to the bottom surface; and
opposing side surfaces extending along the rear surface from the opening to the bottom surface.

14. The sound enhancing device of claim 13, wherein the rear surface is sloped or curved.

15. The sound enhancing device of claim 14, wherein one or both of the opposing side surfaces is sloped or curved.

16. The sound enhancing device of claim 13, wherein the opening is separated from the bottom surface by:
at least 2 mm, at least 3 mm, at least 4 mm, or at least 5 mm;
less than 10 mm, less than 9 mm, less than 8 mm, or less than 7 mm; or
4-9 mm, 4.5-7.5 mm, or 5-7 mm.

17. A mobile device docking station, comprising the sound enhancing device of claim 13 and an electrical connection interface configured to mate with a mobile device for which the device case is configured.

18. A method of enhancing, focusing, or amplifying sound from a mobile device, the method comprising:
inserting a mobile device into the mobile device case of any one of claims 1-5;
emitting sound from the mobile device through the opening; and
enhancing, focusing, or amplifying the sound emitted from the mobile device by means of the sound enhancing element.
